(19) United States
(12) Patent Application Publication
(10) Pub. No.: US 2004/0202011 A1
(43) Pub. Date: Oct. 14, 2004

(54) Control system for lamps and the like

(76) Inventor: Peter Lee, Huntington Beach, CA (US)

Correspondence Address: Norman E. Carte, Myers Dawes Andras & Sherman LLP, 19900 MacArthur Blvd, Suite 1150, Irvine, CA, 92612, US

(21) Appl. No.: 10/412,062

(22) Filed: Apr. 10, 2003

(51) Int. Cl. F21S 4/00

(52) U.S. Cl. 362/802; 307/116

(57) ABSTRACT

A method for controlling an electrical device includes installing a switch return mechanism upon a previously installed wall switch, the switch return mechanism causing the wall switch to return to an on state after being switched to an off state; plugging a power cord of the electrical device into a controller; and plugging the controller into an outlet controlled by the wall switch. The controller is configure to control application of power to the electrical device in response to a change of state of the wall switch and in response to a change of state of at least one other switch.

### BACKGROUND OF THE INVENTION

1. Field of the Invention

The present invention relates generally to electronic control circuitry. The present invention relates more particularly to a control circuit and an associated mechanical device which facilitate turning a lamp or other item on and off from a plurality of different locations without the need to rewire a home or office, without using radio-frequency signals and without using a power signal, such as common 110 VAC power, as a carrier for a control signal. An improved sensing mechanism, i.e., a vibration sensor, is provided to facilitate more reliable control of the lamp or the like.

2. Description of the Prior Art

Most night-stand lamps use a small rotary switch for on/off control thereof. This rotary switch is typically located on the socket of the lamp and it is thus only a few inches away from the hot bulb. It is far too easy for someone to accidentally touch the hot bulb when reaching for the switch, especially if that person is very young, elderly, or infirm. Touching the hot bulb can result undesirable injury to a person and/or even more serious consequences if the person falls or the lamp is knocked over and/or starts a fire.

Further, the small rotary switch provided on most night stand lamps requires a fair amount of turning force for activation. Turning this rotary switch can be very difficult to someone who is very young, elderly, or infirm. Indeed, some of these rotary switches may be impossible for some people to operate.

Another disadvantage of many bedside night stand lamps is that they are fairly tall (some as much as two feet tall)-and are thus frequently difficult to reach. As a result, a user frequently needs to partially get up and reach over in order to access the lamp switch. Such movement can be very demanding for the elderly and infirm.

Controlling electrical devices such as lamps is generally inconvenient for even the healthiest and most able person. Even a person in perfect health may accidentally touch a hot bulb, as discussed above. Even when no catastrophe results, reaching for and using the small rotary switch provided on many contemporary lamps is inconvenient, at best.

Several attempts have been made in the prior art to facilitate the control of electrical devices and appliances from multiple locations within a home or office. These attempts include rewiring a home or office to add additional switches in convenient locations, using radio-frequency signals to control such items, and using a power signal, such as common 110 VAC power, as a carrier for a control signal which controls such items. Each of these prior art attempts to make the control of an electrical device or appliance more convenient has substantial disadvantages, as discussed in detail below.

Rewiring a home or office to add more convenient switches is expensive. Further, if the desired location of a switch is later changed, further rewiring at an additional expense is generally required. Thus, rewiring a home or office is not typically an adequate solution to the problem.

Using radio frequency control is one alternative to rewiring. Typically one transmitter control is mounted near the bedroom door and another transmitter control is mounted bedside. A control module plugs into the wall outlet to control the lamp. Radio frequency signals from each transmitter control toggle a control module output. The control module output determines the state (off or on) of the lamp.

This type of product is sensitive to RFI (radio frequency interference) and it also requires FCC (Federal Communications Commission) Part 15 Certification as an intentional RF emitter. These products typically operate in the 300 to 500 mHz region and they need to meet strict. FCC emission requirements. Production is costly due to RF alignment and testing. In addition, a battery must be replaced periodically in each transmitter control.

Using radio frequency signals to control electrical devices and appliances in the home or office requires that radio frequency controllers and actuators be purchased and installed. Many people, particularly those who need such conveniences the most, such as the very young, the elderly and the infirm, and either incapable of purchasing such products or are reluctant to do so. The installation of such products requires some degree of technical competence. Additionally, radio-frequency control systems tend to be more elaborate, and thus more expensive, than what is generally desired for the mere control of a single electrical device or appliance, such as a lamp.

Using power, such as common 110 VAC power, as a carrier for a control signal suffers from disadvantages similar to those discussed above with respect to using radio frequency signals for the control of electrical devices and appliances. Such control requires that a higher frequency signal, such as a radio frequency signal, be added to the carrier in order to facilitate the control of electrical devices and appliances. Thus, such use of power signals requires that additional hardware, which is generally undesirably expensive and complex, be purchased and installed.

One example of a product which uses power as a carrier for a control signal is the well known S-10 System. This product is very similar to the radio frequency wireless products described above, except that the S-10 System uses a power line radio frequecy carrier technology for signal transmission. This type of product typically operates in the 100 kHz region and it must also complies with FCC Part 15 Certification as an intentional radio frequency emitter. Since it sends a control signal via the power line, it is also sensitive to interference caused by power line noise.

S-10 receivers or controls are wired into the household electrical system in order to receive signal through the power line. Installation requires some basic knowledge of electricity and how circuit works. This creates a very challenging proposition for many consumers. Another disadvantage of S-10 is that it is sensitive to wiring (or branch circuit) arrangement in a house. For the system to work properly, all transmitter controls and receiver modules must be connected to the same branch circuit so the signals can reach the desired receivers or control modules. It is generally difficult to know whether or not a particular installation will work until the installation is completed. This creates another undesirable challenge for the consumers.

Another alternative is to use a sound activated switch (a Clapper) for lamp control. The disadvantage is that loud background noises such as TV sounds, vacuum cleaner noise, or conversation can falsely trigger the device. It can also be difficult for an arthritis sufferer or other infirm or elderly person to create a loud clapping sound in order to activate the device when needed.

Typically, many personal items, such as picture frames, alarm clocks, and glasses, tend to crowd a night stand. As such it is highly desirable to embed a switch control inside a picture frame so that no new item needs to be placed on the night stand. It is also desirable to make the picture frame function as a touch switch or tap switch since picture frames are not normally touched. This reduces false or undesirable turn ons and turn offs.

Some contemporary radio or alarm clock devices may contain a lamp control switch. Thus, a lamp plugged into the radio or alarm clock can be controlled by this switch. However, such devices do not permit the lamp to be independently controlled from a wall switch, which is a highly desirable feature.

As such, although the prior art has recognized, to a limited extent, the problem of using electrical devices and appliance by the very young, the elderly, and the infirm, the proposed solutions have, to date, been ineffective in providing a satisfactory remedy.

Additionally, data recently released by the American Arthritis Foundation reveals that there are more than 57 million Americans who suffer some form of arthritis. Thus, there is a substantial need to lessen the burden and difficulty of using night stand lamps and similar electrical devices and appliances.

### BRIEF SUMMARY OF THE INVENTION

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

The present invention specifically addresses and alleviates the above mentioned deficiencies associated with the prior art. More particularly, according to one aspect the present invention comprises a method for controlling an electrical device, the method comprising installing a switch return mechanism upon a previously installed switch and causing the switch return mechanism to cooperate with the switch to provide a control signal which varies a state of operation of an electrical device.

According to one aspect, the present invention comprises a method for controlling an electrical device, the method comprising installing a switch return mechanism upon a previously installed wall switch, the switch return mechanism causing the wall switch to return to an on state after being switched to an off state, plugging a power cord of the electrical device into a controller, and plugging the controller into an outlet controlled by the wall switch. The controller is configure to control application of power to the electrical device in response to a change of state of the wall switch and also in response to a change of state of at least one other switch, such as a bedside or nightstand switch. This switch may be embedded in a picture frame, so the user can replace an existing picture frame without introducing additional clutter. Incorporating a switch into a picture frame would be unlikely to cause any operational concerns, since a user normally does not touch the picture frame. That is, the user is not likely to unintentionally touch the picture frame and cause the lamp to go on and off.

According to one aspect, the present invention comprises a switch return mechanism for facilitating control of an electrical device via a switch, the switch return mechanism comprising a biasing mechanism configured to causing the switch to return to an on state after being switched to an off state and the switch return mechanism being configured to be installed onto a previously installed switch.

According to one aspect, the present invention comprises a control system for controlling an electrical device from a plurality of locations, the control system comprising a switch return mechanism configured to be installed upon a previously installed wall switch, the switch return mechanism causing the wall switch to return to an on state after being switched to an off state, and a controller configured to be plugged into an outlet controlled by the wall switch, the controller being further configured to control application of power to the electrical device in response to a change of state of the wall switch and in response to a change of state of at least one other switch.

According to one aspect, the present invention comprises a picture frame comprising a frame configured to mount at least one picture, a vibration sensor (such as a piezoelectric sensor), or a proximity switch and an illuminator configure to illuminate the picture(s). The vibration sensor or proximity switch is configured to sense the tapping, touching, or lifting of the frame and optionally to effect illumination of the picture(s) in response thereto. The picture frame assembly is preferably connected to the controller via a 3.5 mm stereo connector or the like.

According to one aspect, the present invention comprises a switch for controlling the operation of an electrical device, the switch comprising a vibration -sensor configured to effect the application of power to the electrical device when a vibration is sensed and configured to discontinue the application of power when a subsequent vibration is sensed.

According to one aspect, the present invention comprises a picture frame comprising a frame configured to mount at least one picture, a vibration sensor or proximity switch and a circuit board that contains electronic components. The vibration sensor or proximity switch is configured to sense lifting vibration or touching of the frame and optionally to illuminate the picture and/or frame in response thereto. The picture frame may either be used alone or in combination with a lamp or other device such that actuating the picture frame optionally also effects control of the lamp or other device.

According to one aspect, the present invention comprises a method for controlling an electrical device, the method comprising generating control signals using a switch that controls application of power to the electrical device, the control signals comprising momentary interruptions in the power provided to the electrical device by the switch.

According to one aspect, the present invention comprises a method for generating a control signal, the method comprising momentarily interrupting power to an electrical device.

These, as well as other advantages of the present invention, will be more apparent from the following description and drawings. It is understood that changes in the specific structure shown and described may be made within the scope of the claims, without departing from the spirit of the invention.

### BRIEF DESCRIPTION OF THE DRAWINGS

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

FIG. 1 is a semi-schematic representation of a typical contemporary nightstand lamp showing the electrical connection thereof to household 110 VAC via a wall socket and wall switch;

FIG. 2 is a high level block diagram of the control system of the present invention;

FIG. 3 is a detailed block diagram of the control system of the present invention;

FIG. 4 is a semi-schematic perspective view showing some of the major components of the control system for lamps and the like of the present invention as it may be used to control the operation of a lamp;

FIGS. 5 is a perspective front/side view of an exemplary picture frame according to the present invention;

FIG. 6 is a front view of one exemplary embodiment of the switch return mechanism or wall switch adapter plate of the present invention;

FIG. 7 is a side view of the exemplary embodiment of the switch return mechanism of FIG. 6;

FIG. 8 is a front view of another exemplary embodiment of the switch return mechanism or wall switch adapter plate of the present invention; and

FIG. 9 is a side view of the exemplary embodiment of the switch return mechanism of FIG. 8.

### DETAILED DESCRIPTION OF THE PREFERRED EMBODIMENTS

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

Although frequently describe herein as operating a lamp, those skilled in the art will appreciate that the present invention is likewise suitable for operating a variety of different electrical devices or appliances. Such devices include, but are not limited to, lamps and other lighting/illumination devices, radios, televisions, video recorders/players (VCRs), digital video devices (DVDs), and computers. Thus, the description herein with respect to a lamp is by way of example only and not by way of limitation.

As described herein, the term operate is generally defined to include turning on and turning off an electrical device. However, the term operate also includes, where appropriate for the particular electrical device, effecting other desired changes of state of the device. For example, the brightness of a lamp may be varied according to the present invention. Thus, the present invention may generally be used to control states of an electrical device which vary with the amount of current provided to the device or to some component or portion of the device.

As mentioned above, most night-stand lamps use a small rotary switch for on/off control thereof. This rotary switch is located on the socket of the lamp and it is only a few inches away from the hot bulb. It is far too easy for someone to accidentally touch the hot bulb when reaching for the switch, especially if that person is very young, elderly, or infirm. The present invention mitigates this concern because a user of the present invention only needs to touch or tap a picture frame or other object in order to turn lamp on and off. The picture frame or other object is located at a safe distance from the hot bulb and is more convenient to reach than the on/off switch of the lamp.

As also mentioned above, the small rotary switch provided on most nightstand lamps requires a fair amount of turning force for activation. This could be very difficult to someone who is very young, elderly, or infirm. The present invention solves this problem by using a gentle tapping or touching action instead of a turning motion.

As also mentioned above, another disadvantage of most bedside or nightstand lamps is that they are fairly tall (some as much as two feet tall) and are thus difficult to reach. As a result, a user sometimes needs to partially get up and reach over in order to access the lamp switch. This could be very demanding to the elderly and infirm. The present solves this problem because its touch control is easily within arm's reach.

According to one aspect, the present invention comprises a method for controlling an electrical device, the method comprising installing a switch return mechanism upon a previously installed switch and causing the switch return mechanism to cooperate with the switch to provide a control signal which varies a state of operation of an electrical device. It should be noted that this switch return mechanism can alternatively be incorporated inside a wall switch for a more attractive design.

According to one aspect, the present invention comprises a method for controlling an electrical device, wherein the method comprises installing a switch return mechanism upon a previously installed wall switch, the switch return mechanism causing the wall switch to return to an on state after being switched to an off state, plugging a power cord of the electrical device into a controller, and plugging the controller into an outlet controlled by the wall switch. The controller is configure to control application of power to the electrical device in response to a change of state of the wall switch and in response to a change of state of at least one other switch.

Preferably, the switch return mechanism is configure to be installed upon a rocker wall switch. Preferably, the switch return mechanism causes the switch to return to the on state immediately after the switch has been switched to the off state.

Preferably, at least one of the other switch(es) is wired to the controller. Preferably, at least one of the other switch(es) comprises a vibration sensor. Preferably, at least one of the other switch(es) comprises a proximity switch. Preferably, at least one switch(es) is part of a picture frame.

Preferably, the switch return mechanism comprises a spring for causing the wall switch to return to the on position after being moved to the off position. Preferably, the switch return mechanism comprises a spring driven arm or plunger for causing the wall switch to return to the on position after being moved to the off position. Preferably, the switch return mechanism is configured to be installed upon a wall switch without modification of the wall switch. Preferably, the switch return mechanism is installed upon the wall switch by removing the wall switch faceplate mounting screws, placing the switch return mechanism over the faceplate of the wall switch, and reinstalling the faceplate mounting screws.

Thus, according to one aspect, the present invention comprises a switch return mechanism for facilitating control of an electrical device via a switch, the switch return mechanism comprising a biasing mechanism configured to causing the switch to return to an on state after being switched to an off state and the switch return mechanism be configured to be installed onto a previously installed switch. An override latch may be built into the switch return mechanism so as to override the spring. The override latch permits the wall switch to return to its normal toggling function without physically removing the mechanism.

According to one aspect, the present invention comprise a control system for controlling an electrical device from a plurality of locations, the control system comprising a switch return mechanism configured to be installed upon a previously installed wall switch, the switch return mechanism causing the wall switch to return to an on state after being switched to an off state, and a controller configured to be plugged into an outlet controlled by the wall switch, the controller being further configured to control application of power to the electrical device in response to a change of state of the wall switch and in response to a change of state of at least one other switch.

According to one aspect, the present invention comprises a picture frame comprising a frame configured to mount at least one picture, a vibration sensor, and an illuminator configure to illuminate the picture(s). The vibration sensor is configured to sense the tapping, touching, lifting or movement of the picture frame and optionally to effect illumination of the picture(s) in response thereto.

The illuminator is preferably powered by batteries. However, the illuminator may alternatively be powered by any other desired means, such as by household power (typically 110 VAC), solar power, etc. The sensor preferably comprises a vibration sensor. However, the sensor may alternatively be a capacitance sensor, an inductance sensor, or any other desired type of sensor.

Optionally, a light sensor is configured such that the illuminator only illuminates the picture(s) when ambient lighting is below a predetermined threshold value.

Optionally, an audio circuit is configured to reproduce an audio message when the proximity switch senses the presence of a person.

According to one aspect, the present invention comprises a switch for controlling the operation of an electrical device, the switch comprising a vibration sensor configured to effect the application of power to the electrical device when a vibration is sensed and configured to discontinue the application of power when a subsequent vibration is sensed.

According to one aspect, the present invention comprises a picture frame configured to mount at least one picture, a vibration switch or proximity sensor, and an audio circuit configured to reproduce an audio message. The vibration switch proximity switch is configured to sense a gentle tapping, touching, or proximity of a person and to effect reproduction of the audio message when the presence of a person is sensed.

Thus, the picture frame may comprise either an illuminator, an audio circuit, or both an illuminator and an audio circuit.

Referring now to FIG. 1, a contemporary bedside or nightstand lamp 10 has a rotary switch 11 and is controlled by a wall switch 12 to form a two-way on/off control because both switches are connected in series. Of course, in this prior art configuration, each switch, 11 and 12, works only if the other is already in the on position.

By way of contrast, a contemporary three-way lamp control (not shown), which is provided in some homes and offices, allows a user to turn on or off a lamp from two different locations (such as a bedside wall switch and an entryway wall switch) without any such restriction. Three-way control of a night-stand lamp is highly desirable due to its convenience. This convenience should further promote energy saving practices by making it easy to turn off a lamp when leaving a room. However, upgrading household wiring to provide such three-way control is very expensive and time consuming.

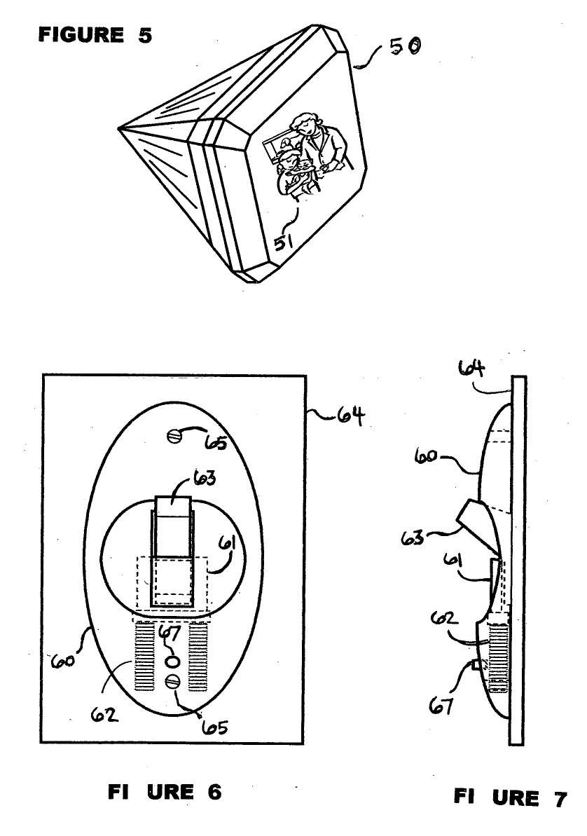

The present invention upgrades a contemporary two-way function to a three-way function without any wiring change. The present invention includes a wall switch adapter plate or switch return mechanism which facilitates such functionality. This adapter plate or switch return mechanism is designed to mount on top of the wall switch as shown in FIGS. 6 and 7 and discussed below. The wall switch adapter plate or switch return mechanism has a spring loaded arm plunger which maintains the wall switch in its on position at all times other than when the wall switch is being momentarily depressed. This guarantees that electricity is available to the lamp control module and the lamp. Thus the user can control the lamp using a second switch (or even more switches, if desired) as discussed below.

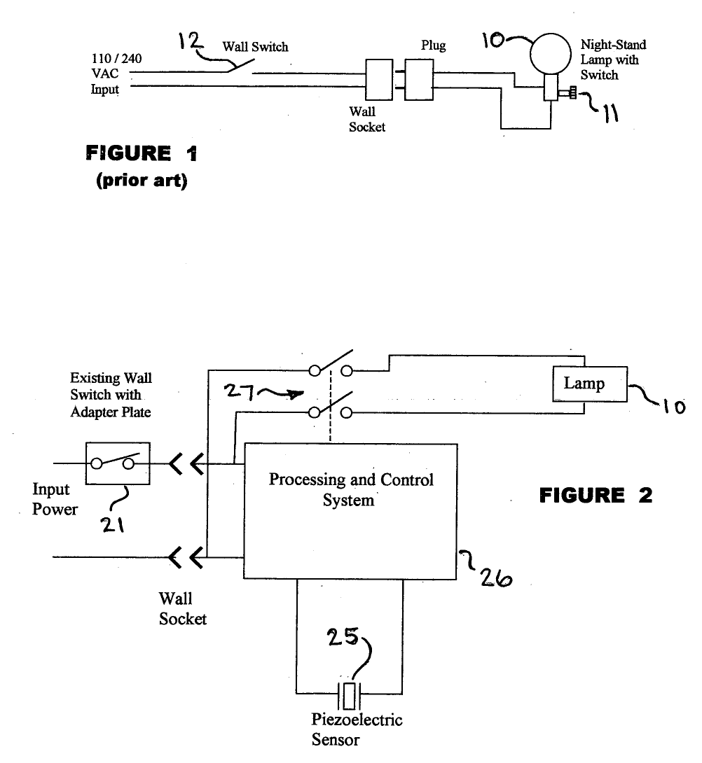

With the installation of the wall switch adapter plate or switch return mechanism, the user can now toggle the wall switch from on to off and interrupts the electricity to processing and control system 26 (FIG. 2) momentarily. This momentary interruption signals the lamp control module to toggle its output state.

Should there be a need to revert back to the original configuration (2-way control), the user simply removed the wall switch adapter plate or switch return mechanism. Or the user simply presses the override latch while maintaining the wall switch in its off position. To remove the override, just pull out the latch.

Referring now to FIG. 2, a block diagram or system diagram of the present invention is provided. Input power, such as 110 VAC, is connected to the system via switch 21. Switch 21 is typically a wall switch, but alternatively may be any other type of switch.

As those skilled in the art will appreciate, wall switches are typically toggle switch which remain in the position (on or off) to which they are set unit they are set to a new position. That is, contemporary wall switches are not momentary switches.

However, in order to function in the desired manner, such a contemporary wall switch is modified by adding the wall switch adapter plate or spring return mechanism 60 shown in FIGS. 6 and 7. The wall switch adapter plate or spring return mechanism converts the contemporary wall switch into a momentary off switch. That is, with the wall switch adapter plate or spring return mechanism 60 installed upon a contemporary wall switch, the switch is spring biased in the on position and returns immediately back to the on position after being moved momentarily to the off position. Two types of wall switch designs are commonly used in home construction. Accordingly, two different return mechanisms are discussed herein.

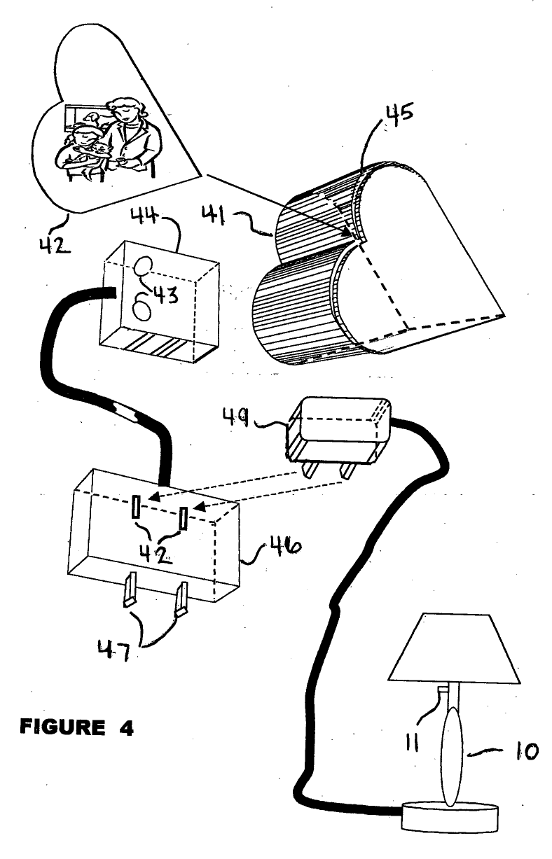

It is possible to use the lamp control module 46 (FIG. 4) of the present invention without installing a wall switch adapter plate or switch return mechanism upon the wall switch which controls the lamp. However, in this instance, the user must remember to return the wall switch to the on position when turning the lamp off from the wall switch. In order to make the present invention more convenient for the user, it is preferred that the wall switch adapter plate or switch return mechanism be utilized.

By converting the wall switch (FIG. 2) 21 into a momentary switch, the wall switch 21 becomes a controller for the lamp control module 46 (FIG. 4). That is, one actuation of the wall switch 21 signals the lamp control module 46 to turn on the lamp 10 and the next actuation of the wall switch 21 signals the lamp control module 46 to turn off the lamp 10. Power is always available to the lamp 10, since the wall switch adapter plate 60 causes the wall switch 21 to return to the on position each time that it is used.

Thus, the wall switch 21 serves a dual purpose. It both connects the input power to the system as well as generating a command signal when momentary depressed.

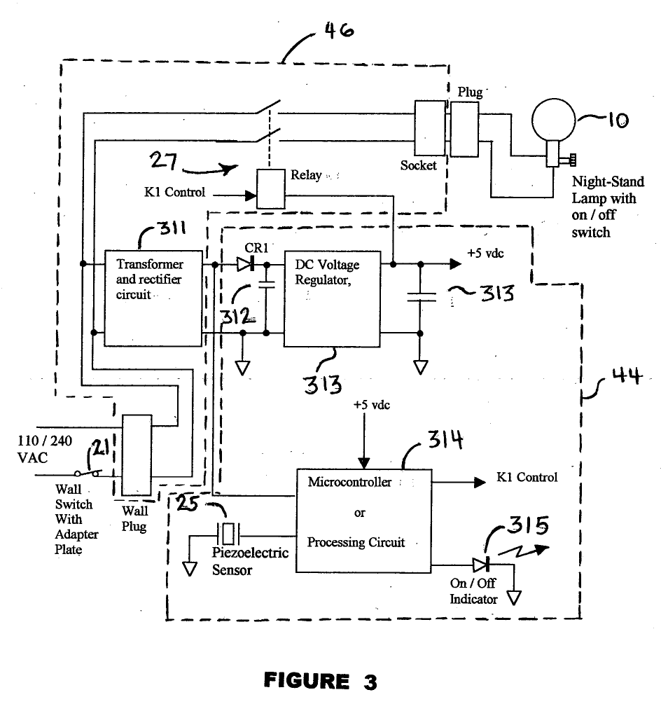

Multiple wall switches 21 and/or sensors 25 (FIGS. 2 and 3) may be utilized so as to increase system control and convenience.

The processing and control system 26 (FIG. 2) develops an internal operating voltage for the internal processing circuitry. Circuits include signal conditioning amplifiers and digital components configure to process the command signals from both wall switch 21 and piezoelectric sensor 25. After a logical decision is made, a power relay 27 (FIGS. 2 and 3) or solid state transistor may be used to switch the output to the load.

A small piezoelectric disc sensor (about one inch in diameter) is preferred for piezoelectric sensor 25 due to its low cost, ease of production and ruggedness. It is preferably mounted on a circuit board and requires a gentle tapping for activation. Tapping transmits a mechanical vibration to the disc. In response to this mechanical vibration, the disc outputs a small electrical signal that is proportional to the vibration. A high gain amplifier is preferably configured to amplify and shape this signal into a pulse waveform for processing. A photo-electric sensor may also be utilized for the same purpose. Unlike most touch lamp controls in the market which relies on a metallic surface for sensing, piezoelectric sensor or photo-electric sensors do not require direct metallic contact. Metallic contact sensor is less desirable in a high voltage appliance due to safety concern.

The use of such a vibration or proximity switch in the present invention creates a magical illusion that no mechanical switch is required to activate the picture frame touch control. Such operation thus provides enhanced convenience.

A printed circuit board or metallic surface is preferably embedded behind a photo frame. It provides mechanical support for the piezoelectric sensor and the associated signal processing circuits. This created a dynamic or active picture frame where a LED lights up in response to touching or tapping. Unlike conventional touch lamp control, this design requires no direct metallic contact for activation. Thus, significant safety improvement is realized due to the presence of dangerous operating voltage (110 to 240 VAC).

Thus, in response to touching or tapping, an LED optionally lights up and enhances the appearance of the photo frame. This LED may be set to time out after certain preset time to conserve power. This is particularly desirable if the LED is powered by a battery.

Referring now to FIG. 3, a more detailed schematic of the processing and control system and its connection to household power and a lamp according to the present invention is provided.

The circuit components shown in the block diagram of FIG. 3 are housed either in the lamp control module 46 or in the touch control module 44 of the photo frame (see FIG. 4).

Transformer and rectifier circuit 311 isolates and lowers the incoming AC voltage from 110 volt to a convenient operating voltage. The rectified output voltage is filtered by capacitor 312 and then applied to the input of DC voltage regulator 313. DC voltage regulator 313 outputs a 5-volt DC for circuit operation. Capacitor 313 has a large capacitance (1000 microFarads or more). Its main purpose is to store enough current to maintain normal circuit operation in case of a momentary brown out.

When a user taps the picture frame 41 (FIG. 4) or other item containing the piezoelectric switch sensor 25, it signals microcontroller 314 to toggle output “K1 Control” to a state opposite to its present state. If the output is at the low state, relay 27 activates. Contacts of relay 27 connect electricity to the lamp 10. When the user taps the picture frame or other item again, the microcontroller 314 toggles output “K1 Control” again—this time to a high state. This deactivates relay 27 and disconnects electricity to the lamp 10. On/off indicator(s) 315 are optionally also controlled by microcontroller 314 to provided an indication of whether the lamp is in the on state or the off state. This same indicator also lights up the picture frame as previously discussed. This indicator may be useful if the lamp is turned off by its own switch, so that a user will know that the vibration sensor or proximity switch is functioning properly and that the lamp switch needs to be turned on. An indicator or other light may optionally be turned on at all times, so that a user can find the device in the dark.

With the installation of the wall switch adapter plate or switch return mechanism 60 (FIGS. 6 and 7), the user can now momentary toggle the wall switch 21 to interrupt the flow of electricity to transformer and rectifier circuit 311. Such momentary toggling of the wall switch 21 makes the rectified output of the transformer and rectifier circuit 311 disappear momentarily. Microcontroller 314 detects the absence of this signal as an input command to toggle output “K1 Control” as described above.

Referring now to FIG. 4, a picture frame 41 is configured such that photograph or other piece of artwork 42 can be received within a slot 45 thereof. Preferably, the artwork 42 is backlit by LEDs 43 of touch control module 44. The touch control module 44 can either be disposed within the picture frame 41 or attached to the back thereof.

Rather than a picture frame, a figurine or any other desired item by be configured to contain the touch control module. Indeed, the touch control module may, if desired, merely be a box. Touch control module 44 is preferably connected to lamp control module 46 via a cable with a standard 3.5 mm stereo connector.

The touch control module 44 contains the piezoelectric sensor 25 in FIGS. 2 and 3, as well as the LEDs 43. As those skilled in the art will appreciate, the touch control module 44 may alternative contain any other desired type of switch. For example, the touch control module may alternatively contain a capacitance switch, an inductance switch, an audio (noise activated) switch or a mechanical switch (such as a pushbutton switch or a toggle switch).

The touch control module 44 is in electrical communication with the lamp control module 46. The lamp control module 46 and touch control module 44 contains the processing and control system 26 of FIG. 2. The lamp control system 46 is preferably configured as a module which plugs into a wall outlet via prongs 47, in a fashion similar to that in which the transformers of many consumer electronics products plug into a wall outlet. However, those skilled in the art will appreciate that various other physical configurations of the lamp control module 46 are likewise suitable. For example, the lamp control module 46 may alternatively be configured so as to have a power cord which extends therefrom and which plugs into the wall outlet.

The lamp control module 46 is preferable configured such that the power plug 49 of a lamp 10 or other such electronic device plugs thereinto via plug openings 48. Alternatively, the power plug of the lamp may connect to the lamp control module 46 in any other desired manner. The lamp 10 has a built-in switch 11, typically a difficult to use rotary switch as discussed above.

The picture frame touch control with the lamp control module 44 built integrally thereinto saves space while improving user convenience and safety. Thus, the picture frame contains a sensitive touch switch or proximity switch which controls the output to the night-stand lamp. With this device, the user can activate a night-stand lamp by just tapping or touching the photo frame 41.

Referring now to FIG. 5, an alternative configuration of the picture frame 50 is shown. This alternative configuration is shaped generally in the fashion of a diamond and facilitates the mounting and display of a picture 51. This picture frame 50, as well as the picture frame 45 of FIG. 4, can either be used with the processing and control system 26 (FIG. 2) of the present invention to facilitate three-way control of a lamp or other device or may be used independently.

That is, according to one aspect, the present invention comprises a picture frame which comprises a proximity or other switch, such as a vibration sensor, to cause the picture frame to illuminate and/or produce sound. Such activation of the picture frame may, if desired, also cause the activation of another device, such as a lamp. Indeed, the picture fame is preferably configured to facilitate either mode of operation (with or without a lamp or other device), at the users option.

Referring now to FIGS. 6 and 7, a wall plate switch adapter or switch return mechanism 60 is shown. The wall plate switch adapter or switch return mechanism 60 comprises an arm or plunger 61 which is biased by one or more springs 62 in a manner which causes the toggle 63 of the typically previously installed wall switch 64 to immediately return to the on position after having been momentarily moved to the off position by a user to effect either turning on or turning off of the lamp or other item.

The wall plate switch adapter plate or switch return mechanism of the present invention is installed over an already installed wall switch by simply removing the two plate attachment screws 65, positioning the wall plate switch adapter or switch return mechanism over the wall plate switch 64, and then re-installing the screws 65.

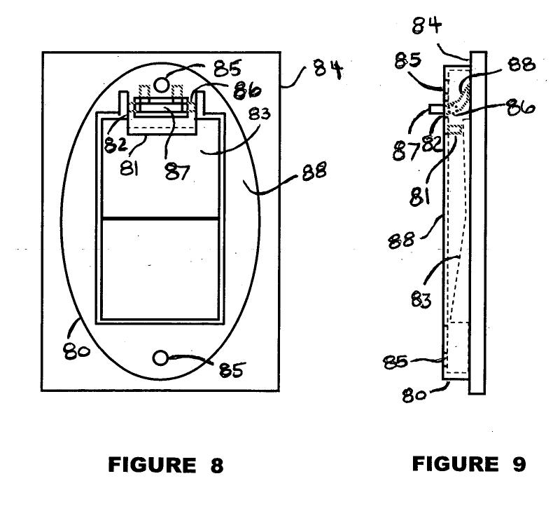

As those skilled in the art will appreciate, there are various different kinds of wall switches. For example, many newer homes and offices have low profile rocker switches, as shown in FIGS. 8 and 9, rather than the higher profile toggle switch illustrated in FIGS. 6 and 7. Of course, the low profile rocker switches and various other types of switches will require a switch return mechanism that is configured somewhat differently from that shown in FIGS. 6 and 7. However, in each instance, the switch return mechanism will comprise a spring biased arm or plunger for causing the switch to return to the on position after it has momentarily been placed in the off position. Thus, the switch return mechanism of the present invention is applicable to a wide variety of different kinds of wall switches and is not limited to the type of wall switch shown in FIGS. 6 and 7.

Optionally, an override latch 67 facilitates normal use of the wall switch 64 by preventing the plunger 61 from moving the toggle 63 back to the on position. By holding the toggle 63 in the off position and simultaneously depressing the override latch 67, the override latch 67 is caused to engage the plunger 61 and hold the plunger 61 in its lowermost position, such that the plunger does not effect upward movement of the toggle 63. In this manner, the switch return mechanism 60 is bypassed and the wall switch functions normally. Pulling the toggle 63 outward slightly releases the override latch and permits the switch return mechanism so as to function once again.

Referring now to FIGS. 8 and 9, an alternative configuration of a wall switch adapter or switch return mechanism 80 is shown. This alternative embodiment of the wall plate switch adapter or switch return mechanism 80 is suitable for the more modern, low profile wall switches. The alternative configuration of the wall plate switch adapter or switch return mechanism 80 comprises an arm 81, which is preferably formed integrally with a cover or body 88 of the switch return mechanism 80. The arm 81 is formed such that it spring biases the toggle 83 of the wall switch in the on position thereof. Thus, spring portion 82 of the arm 81 biases the arm 81 against the top portion of the toggle 83 such that when the bottom portion of the toggle 83 is depressed and then released, the arm 81 pushes toggle 83 back into the on position thereof. Thus, the springs 82 are preferably integrally formed with the arm 81 and the body 88 of the switch return mechanism 80. However, those skilled in the art will appreciate that various other configurations are likewise suitable for causing the toggle 83 to return to the on position after it has been momentarily placed in the off position.

Like the embodiment of the wall place switch adapter or switch return mechanism 60 shown in FIGS. 6 and 7, the embodiment thereof shown in FIGS. 8 and 9 is installed over an already installed wall switch by simply removing the two plate attachment screws 85, positioning the wall plate switch adapter or switch return mechanism 80 over the wall plate switch 84, and then re-installing the screws 85.

Optionally, an override latch 87 facilitates normal use of the wall switch 84 by preventing the arm 81 from moving the toggle 83 back to the on position. By pushing the override latch 87 upwardly, so as to cause it to rotate about pivot pin 86, the inner arm 88 thereof forces the arm 81 outwardly, away from the upper portion of the toggle 83, such that the arm 81 does not bias the toggle 83 in the on position thereof. Rotating the override latch 87 downwardly, thus causing the inner arm 88 thereof to return to the upper most position thereof, as shown in FIG. 9, allows the switch return mechanism 80 to once again function so as to cause the toggle 83 to return to the on position after having been momentarily been placed in the off position.

Thus, a user can, according to the present invention, conveniently control the lamp or other item from either the wall switch or the picture frame touch control without any restriction (without requiring that the other switch be in the on position). Thus, a three-way lamp control function is being realized without any wiring change, without the use of a radio frequency broadcast signal and with the use of the power signal as a carrier for a radio frequency signal or the like.

It is understood that the exemplary control system described herein and shown in the drawings represents only (a) presently preferred embodiment(s) of the invention. Indeed, various modifications and additions may be made to such embodiment(s) without departing from the spirit and scope of the invention. For example, those skilled in the art will appreciate that various different electrical devices, appliance and such may be controlled by the present invention. Further, various different types of switch may be used to control such items. For example, any desired combination of mechanical switches, capacitance switches, inductance switches, and vibration switches may be used according to the present invention.

Thus, these and other modifications and additions may be obvious to those skilled in the art and may be implemented to adapt the present invention for use in a variety of different applications.

1. A method for controlling an electrical device, the method comprising installing a switch return mechanism upon a previously installed switch,and causing the switch return mechanism to cooperate with the switch to provide a control signal which varies a state of operation of an electrical device.

2. A method for controlling an electrical device, the method comprising:
installing a switch return mechanism upon a previously installed wall switch, the switch return mechanism causing the wall switch to return to an on state after being switched to an off state;
plugging a power cord of the electrical device into a controller;
plugging the controller into an outlet controlled by the wall switch; and
wherein the controller is configure to control application of power to the electrical device in response to a change of state of the wall switch and in response to a change of state of at least one other switch.

3. The method as recited in claim 2, wherein the switch return mechanism is configure to be installed upon a rocker wall switch.

4. The method as recited in claim 2, wherein the switch return mechanism causes the switch to return to the on state immediately after the switch has been switched to the off state.

5. The method as recited in claim 2, further comprising switching a power switch of the electrical device to an on position.

6. The method as recited in claim 2, wherein at least one of the other switch(es) is wired to the controller.

7. The method as recited in claim 2, wherein at least one of the other switch(es) comprises a vibration sensor.

8. The method as recited in claim 2, wherein at least one of the other switch(es) comprises a proximity switch.

9. The method as recited in claim 2, wherein at least one switch(es) is part of a picture frame.

10. The method as recited in claim 2, wherein the switch return mechanism comprises a spring for causing the wall switch to return to the on position after being moved to the off position.

11. The method as recited in claim 2, wherein the switch return mechanism comprises a spring driven plunger for causing the wall switch to return to the on position after being moved to the off position.

12. The method as recited in claim 2, wherein the switch return mechanism is configured to be installed upon a wall switch without modification of the wall switch.

13. The method as recited in claim 2, wherein the switch return mechanism is installed upon the wall switch by removing the wall switch faceplate mounting screws, placing the switch return mechanism over the faceplate of the wall switch, and reinstalling the faceplate mounting screws.

14. A switch return mechanism for facilitating control of an electrical device via a switch, the switch return mechanism comprising a biasing mechanism configured to causing the switch to return to an on state after being switched to an off state and the switch return mechanism be configured to be installed onto a previously installed switch.

15. The switch return mechanism as recited in claim 14, wherein the switch return mechanism is configured to be installed onto a wall switch.

16. The switch return mechanism as recited in claim 14, wherein the biasing mechanism comprises at least one spring configured to cause the switch to return to the on position after being switched to the off position.

17. The switch return mechanism as recited in claim 14, wherein the biasing mechanism comprises at least one spring configured to cause a toggle of the switch to return to the on position after the toggle has been move to the off position.

18. The switch return mechanism as recited in claim 14, wherein the biasing mechanism comprises at least one spring driven plunger configured to cause a toggle of the switch to return to the on position after the toggle has been move to the off position.

19. The device as recited in claim 14, further comprising a switch return mechanism configured to be installed over a wall switch.

20. The device as recited in claim 14, further comprising a switch return mechanism configured to be installed over a wall switch by removing the face plate mounting screws, placing the adapter plate over the face plate, and reinstalling the faceplate mounting screws.

21. A control system for controlling an electrical device from a plurality of locations, the control system comprising:
a switch return mechanism configured to be installed upon a previously installed wall switch, the switch return mechanism causing the wall switch to return to an on state after being switched to an off state; and
a controller configured to be plugged into an outlet controlled by the wall switch, the controller being further configured to control application of power to the electrical device in response to a change of state of the wall switch and in response to a change of state of at least one other switch.

22. The control system as recited in claim 21, wherein the switch return mechanism is configure to be installed upon a rocker wall switch.

23. The control system as recited in claim 21, wherein the switch return mechanism causes the switch to return to the on state immediately after the switch has been switched to the off state.

24. The control system as recited in claim 21, wherein at least one of the other switch(es) is wired to the controller.

25. The control system as recited in claim 21, wherein at least one of the other switch(es) comprises a vibration sensor.

26. The control system as recited in claim 21, wherein at least one of the other switch(es) comprises a proximity switch.

27. The control system as recited in claim 21, wherein at least one switch(es) is part of a picture frame.

28. The control system as recited in claim 21, wherein the switch return mechanism comprises a spring for causing the wall switch to return to the on position after being moved to the off position.

29. The control system as recited in claim 21, wherein the switch return mechanism comprises a spring driven plunger for causing the wall switch to return to the on position after being moved to the off position.

30. The control system as recited in claim 21, wherein the switch return mechanism is configured to be installed upon a wall switch without modification of the wall switch.

31. The control system as recited in claim 21, wherein the switch return mechanism is configured to be installed upon the wall switch by removing the wall switch faceplate mounting screws, placing the switch return mechanism over the faceplate of the wall switch, and reinstalling the faceplate mounting screws.

32. A picture frame comprising:
a frame configured to mount at least one picture;
a proximity switch;
a illuminator configure to illuminate the picture(s); and
wherein the proximity switch is configured to sense a presence of a person and to effect illumination of the picture(s) when the presence of a person is sensed.

33. The picture frame as recited in claim 32, wherein the illuminator is powered by batteries.

34. The picture frame as recited in claim 32, wherein the illuminator is powered by batteries contained within the picture frame.

35. The picture frame as recited in claim 32, wherein the sensor comprises a vibration sensor.

36. The picture frame as recited in claim 32, wherein the sensor comprises a capacitance sensor.

37. The picture frame as recited in claim 32, wherein the sensor comprises an inductance sensor.

38. The picture frame as recited in claim 32, further comprising a light sensor configured such that the illuminator only illuminates the picture(s) when ambient lighting is below a predetermined threshold value.

39. The picture frame as recited in claim 32, further comprising an audio circuit configured to reproduce an audio message when the proximity switch senses the presence of a person.

40. A switch for controlling the operation of an electrical device, the switch comprising a vibration sensor configured to effect the application of power to the electrical device when a vibration is sensed and configured to discontinue the application of power when a subsequent vibration is sensed.

41. A picture frame comprising:
a frame configured to mount at least one picture;
a proximity switch;
an audio circuit configured to reproduce an audio message; and
wherein the proximity switch is configured to sense a presence of a person and to effect reproduction of the audio message when the presence of a person is sensed.

42. A method for controlling an electrical device, the method comprising generating control signals using a wall switch having a switch return mechanism installed thereon, that controls application of power to the electrical device, the control signals comprising momentary interruptions in the power provided to the electrical device by the switch.

43. A method for generating a control signal, the method comprising momentarily interrupting power to an electrical device using a wall switch having a switch return mechanism added thereto.

44. A method for controlling an electrical device, the method comprising generating control signals using an existing wall switch that controls application of power to the electrical devices, the control signals comprising momentary interruptions in the power provided to the electrical devices by the switch.
